(19) United States
(12) Patent Application Publication
(10) Pub. No.: US 2016/0338348 A1
(43) Pub. Date: Nov. 24, 2016

(54) SOLVENT SYSTEMS FOR PRODUCING PUMPABLE FORMULATION OF HIGH ACTIVE ETHER SULFATES

(71) Applicant: ADJUVANTS UNLIMITED, LLC, Memphis, TN (US)

(72) Inventors: Jason Rader, Collierville, TN (US); Jennifer Jordan Bear, Cordova, TN (US); Gregory Martin McManic, Germantown, TN (US); Kevin Edward Crosby, Germantown, TN (US)

(73) Assignee: Adjuvants Unlimited LLC, Memphis, TN (US)

(21) Appl. No.: 15/106,598

(22) PCT Filed: Dec. 19, 2014
(86) PCT No.: PCT/US14/71723

§ 371 Date: Jun. 20, 2016

Related U.S. Application Data
(60) Provisional application No. 61/918,523, filed on Dec. 19, 2013.

(51) Int. Cl. A01N 25/02; A01N 25/30; A01N 57/20

(52) U.S. Cl. CPC A01N 25/02; A01N 57/20; A01N 25/30

(57) ABSTRACT

Novel methods and compositions are provided for reducing the viscosity of high active alkyl ether sulfate surfactants (e.g., 70% sodium lauryl ether sulfate) without using highly flammable solvents or preservatives.

### CROSS-REFERENCE TO RELATED APPLICATIONS

This application is a national phase application of International Patent Application No. PCT/US2014/071723 filed on Dec. 19, 2014, which claims the benefit of U.S. Provisional Application No. 61/918,523, which was filed Dec. 19, 2013, both of which are hereby incorporated by reference in their entirety for all that they teach.

### FIELD OF THE INVENTION

The present invention relates to surfactant compositions with improved ease of handling and pumping using non-specialized equipment which eliminates the use of flammable solvents.

### BACKGROUND OF THE INVENTION

In the surfactant art, some water soluble products are produced in concentrated form for improved resistance to microbial degradation and energy efficiency, with both of these being related to the amount of water present in the composition. Lower water content inhibits microbial growth and eliminates the need for preservatives, but removing all traces of water can require large amounts of energy. In the industry, such forms of surfactants are known as “high active” and are used with surfactant products such as sodium lauryl ether sulfate (“SLES” or “sodium laureth sulfate”).

In concentrated forms of some surfactants, a gel phase occurs when the surfactant concentration passes a threshold level and there is not enough water present to ensure solubility of the surfactant. A particular example of this problem occurs with SLES, which forms a gel phase when the surfactant concentration exceeds approximately 27% of an aqueous solution. When a gel phase forms, SLES is difficult to pump using conventional pumps (such as diaphragm type pumps) and specialized equipment (such as positive displacement or tri-lobe pumps) is required.

Additionally, such concentrated forms of SLES can exhibit instability when unexpectedly heated above approximately 140° F. The product can hydrolyze, releasing sulfuric acid, thus damaging process equipment. The heat of a product process reaction, once it is started, does not dissipate because of the gel nature of high active SLES. This can lead to very high temperatures in the process reaction, and further lead to a runaway reaction, which can destroy the whole batch of product. Of great interest to the surfactant community is a more dilute form(s) of SLES, while also eliminating the problems of (1) microbial contamination, (2) gel phase formation and attendant high viscosity, and (3) high reactivity.

One method for overcoming the high viscosity of high active surfactants has been the addition of volatile solvents (such as iso-propanol). However, this is a flammable solvent, which results in safety concerns in mixing and shipping operations. Other flammable solvents have been reported for some applications. See U.S. Pat. Nos. 7,842,647 & 8,445,406 (the “Long patents”; both hereby incorporated by reference in their entirety). Additional solvents are needed to allow for dilution of high active surfactants for specific uses, including in cleaning and pesticide formulations.

### SUMMARY OF THE INVENTION

The present invention alleviates the problems of the prior art discussed above by providing novel methods for reducing viscosity of high active alkyl ether sulfates (e.g., sodium lauryl ether sulfate or ammonium lauryl ether sulfate) by mixing said high active alkyl ether sulfates with one or more solvents (solvent blend) and novel compositions with reduced the viscosity of the surfactants prior to use. The present invention accomplishes these goals without use of flammable solvents or the requirement of using a preservative. The resulting mixtures (surfactant-solvent blends, surfactant-solvent blend solutions, and liquid agrochemical compositions) can be easily pumped, once blended, over a temperature range of about 4-50° C., without the need for special equipment. These resulting surfactant-solvent blends can be used to formulate cleaning products or pesticides, including herbicides. The surfactant-solvent blends described are stable and do not separate upon storage or at elevated (e.g., 50° C.) or low (e.g., 4° C.) temperatures. The described blends have viscosities in the range of 300-1000 cps at 20° C. and are generally clear in appearance. These blends can be readily transported in jugs, pails, drums, totes, or in bulk containers without the need for special equipment to unload the shipping and/or storage containers.

Therefore, according to one aspect, the invention comprises a method for reducing the viscosity of a high active (concentrated at 27-70%) alkyl ether sulfate surfactant solution comprising providing a high active concentrated alkyl ether sulfate surfactant solution and mixing hexylene glycol as a solvent into said high active concentrated alkyl ether sulfate surfactant solution. In some embodiments, said high active concentrated alkyl ether sulfate surfactant is selected from the group comprising sodium lauryl ether sulfate and ammonium lauryl ether sulfate. In other embodiments, at least one co-solvent in the amount of about 0.1% to about 90% of the total solvent amount by weight is further mixed into said high active concentrated alkyl ether sulfate surfactant solution. In yet further embodiments, at least one co-solvent is selected from the group consisting of diethylene glycol, ethylene glycol, proplyene glycol, diproplyene glycol methyl ether, propylene glycol monomethyl ether, or combinations thereof is/are mixed into said high active concentrated alkyl ether sulfate surfactant solution. In preferred embodiments, said at least one co-solvent is diethylene glycol. In further preferred embodiments, said at least one co-solvent is a combination of diethylene glycol and propylene glycol monomethyl ether. In still further preferred embodiments, at least one additional surfactant selected from the group consisting of alkylpolyglucosides and alcohol alkoxylates in amount of about 0.1% to about 50% by weight is further mixed into said high active concentrated alkyl ether sulfate surfactant solution.

According to another aspect, the invention comprises a method for treating an agricultural substrate comprising contacting said agricultural substrate with a sufficient amount of a liquid agrochemical composition spray solution containing a surfactant-solvent blend comprising a high active concentrated alkyl ether sulfate surfactant solution and a solvent mixed into said high active concentrated alkyl ether sulfate surfactant solution, wherein said solvent is hexylene glycol. In some embodiments, said liquid agrochemical composition spray solution comprises an active agrochemical agent selected from the group consisting of a herbicide, an insecticide, a fungicide, a miticide, a fertilizer, or a plant growth regulator, or combinations thereof. In preferred embodiments, said herbicide is glufosinate or salts thereof.

According to yet another aspect, the invention comprises a liquid agrochemical composition comprising an active agrochemical agent and a surfactant-solvent blend solution, wherein said surfactant-solvent blend solution comprises a high active (concentrated at 27-60%) alkyl ether sulfate surfactant solution and a hexylene glycol solvent. In some embodiments, said high active concentrated alkyl ether sulfate surfactant is selected from the group comprising sodium lauryl ether sulfate and ammonium lauryl ether sulfate. In other embodiments, said hexylene glycol solvent comprises about 1% to about 5% by weight of said composition. In further embodiments, at least one co-solvent is selected from the group consisting of diethylene glycol, ethylene glycol, proplyene glycol, diproplyene glycol methyl ether, propylene glycol monomethyl ether, or combinations thereof is/are mixed into said high active concentrated alkyl ether sulfate surfactant solution. In preferred embodiments, said at least one co-solvent is diethylene glycol. In further preferred embodiments, said at least one co-solvent is a combination of diethylene glycol and propylene glycol monomethyl ether. In still further embodiments, said at least one co-solvent in the amount of about 5% to about 80% of the total solvent amount by weight is further mixed into said high active concentrated alkyl ether sulfate surfactant solution. In still further preferred embodiments, said high active concentrated alkyl ether sulfate surfactant comprises about 75% to about 90% of the total surfactant amount by weight in said composition. In yet other embodiments, at least one additional surfactant selected from the group consisting of alkylpolyglucosides and alcohol alkoxylates is further mixed into said high active concentrated alkyl ether sulfate surfactant solution. In yet further preferred embodiments, said at least one additional surfactant comprises about 0.1 to about 50% by weight of said composition.

### DETAILED DESCRIPTION OF INVENTION

The following detailed description is presented to enable any person skilled in the art to make and use the invention. For purposes of explanation, specific details are set forth to provide a thorough understanding of the present invention. However, it will be apparent to one skilled in the art that these specific details are not required to practice the invention. Descriptions of specific applications are provided only as representative examples. Various modifications to the preferred embodiments will be readily apparent to one skilled in the art, and the general principles defined herein may be applied to other embodiments and applications without departing from the scope of the invention. The present invention is not intended to be limited to the embodiments shown, but is to be accorded the widest possible scope consistent with the principles and features disclosed herein.

A particular interest in the field is the development of a sodium lauryl ether sulfate (“SLES” or “sodium laureth sulfate”) or ammonium lauryl ether sulfate (“ALES” or “ammonium laureth sulfate”) solution for formulators (or “users”) who neither possess the specialized equipment required to handle high active surfactant nor the storage capability for large quantities of flammable material (i.e., volatile organic solvents). For these users, a pumpable and non-flammable version of SLES containing up to 60% surfactant but greater than 27% surfactant (maximum aqueous solution SLES concentration without a gel phase) that does not require preservatives is desirable. A formulation of SLES that fits these criteria will allow the surfactant to have a greater utility in terms of both more applications and a wider range of potential users.

The use of a non-flammable or reduced-flammability solvent is needed in order to produce a non-flammable, free-flowing solution of SLES that avoids a gel phase by diluting high active SLES (approximately 70% SLES and approximately 30% water). Preferably, the solvent selected should be efficient at reducing the viscosity of the surfactant and readily available. More preferably, the solvent selected should also result in a single phase or substantially single phase solution, where substantially single phase is defined as minimally or slightly cloudy in appearance.

During our research into this problem, we unexpectedly discovered that hexylene glycol was an effective solvent for creating surfactant-solvent blend solutions of high active alkyl ether sulfate surfactants (see Tables 1-3). In addition, we have discovered hexylene glycol is also useful for the purpose of making an easily pumpable solution of high active alkyl ether sulfate surfactants that can be readily transported in common and non-hazardous shipping containers. Previously, blends of the solvents THFA and dipropylene glycol with the solvents iso-propanol or 1-butanol have been claimed to be useful solvent blends for SLES in concentrated herbicide formulations (see the Long patents). However, THFA, iso-propanol and 1-butanol pose significant fire safety hazards.

In addition to decreasing the viscosity of high active SLES, hexylene glycol also can be used as a component of pesticide and herbicide formulations because it is an approved inert ingredient according to the U.S. Environmental Protection Agency (see U.S. EPA InertFinder). Further anticipated applications for the hexylene glycol diluted high active SLES solutions of the present invention include formulations for cleaning products, such as soaps, detergents, shampoos, and similar products.

For the above reasons, hexylene glycol is uniquely qualified as a solvent to produce a surfactant (e.g., SLES) blend solution with properties not currently available (i.e., having improved safety characteristics as compared to current commercial formulations).

In one aspect, the present invention comprises a surfactant-solvent blend solution of a high active alkyl ether sulfate surfactant and hexylene glycol as a solvent. In another aspect, the surfactant-solvent blend solution of the present invention can then be further modified to obtain desired physical or chemical properties. In yet another aspect, the resulting surfactant-solvent blend solution can be used in manufacturing active agent solutions, with or without modification. In still another aspect, the surfactant-solvent blend solution of the present invention can be used to manufacture concentrated active agent solutions, such as concentrated glufosinate-ammonium herbicide solutions and mixtures of glufosinate with other herbicides.

With the decrease in viscosity afforded by hexylene glycol, other solvents and surfactants may then be added to the SLES solution without adversely affecting the viscosity of the solution, but modifying the physical and/or chemical properties of the resulting formulation. For example, non-ionic surfactants such as alkyl polyglucosides (“APG”), co-solvents such as diethylene glycol, and other additional components may be added without deleterious effect.

Suitable alkyl ether sulfate surfactants that may be used in the present invention include sodium lauryl ether sulfate, ammonium lauryl ether sulfate, and/or other salts of lauryl ether sulfate. Preferably, the alkyl ether sulfate surfactant is a high active concentrated alkyl ether sulfate surfactant, such as 70% active SLES, ALES, or mixtures thereof, available from BASF. More preferably the alkyl ether sulfate surfactant is a high active SLES. The alkyl ether sulfate surfactant can be manufactured from petroleum or vegetable sources. The alkyl ether sulfate surfactant may be present in the present invention at about 25% to about 60% by weight. In embodiments of surfactant-solvent blend solutions, the preferable range is about 35% to about 50% by weight, and more preferably between about 40% to about 45% by weight. In embodiments of surfactant-solvent blend solution formulas blended with active agrochemical agents (liquid agrochemical compositions), the preferable range is about 25% to about 35% by weight.

In addition to alkyl ether sulfate surfactants, the present invention may optionally contain one or more co-surfactant(s) or additional surfactant(s). Additional surfactants suitable for use in the present invention include non-ionic surfactants, such as alkyl polyglycosides and alcohol alkoxylates. Preferably, the alkyl polyglycosides used in the present invention are alkyl polyglucosides. Examples of suitable commercial alkyl polyglucosides for use in the present invention include AGNIQUE® PG series, such as AGNIQUE® PG-8105, from BASF or similar surfactant products. Preferably, the alcohol alkoxylates used in the present invention are alcohol ethoxylates. Examples of suitable commercial alcohol alkoxylates for use in the present invention include SURFONIC® L series surfactants, such as SURFONIC® L-24-3, from Huntsman International LLC, ECOSURF® EH series surfactants, such as ECOSURF® EH-3 or ECOSURF® EH-6, from Dow Chemical Company, AGNIQUE IDA-6 from BASF Corp., or similar surfactant products. The additional surfactant may be present in the present invention at about 0.1% to about 50% by weight. Preferably, the additional surfactant is present at about 10% to about 20% by weight.

Previously, Long and others taught that the following solvents may be suitable for diluting high active SLES: cyclic alcohols such as tetrahydrofurfuryl alcohol (THFA); aliphatic alcohols, such as alkanols having 1 to 12 carbon atoms, usually 1 to 6 carbon atoms, such as methanol, ethanol, propanol, iso-propanol and butanol, for example, or polyhydric alcohols such as ethylene glycol, propylene glycol, dipropylene glycol, and glycerol; ethers such as diethyl ether, tetrahydrofuran (THF), and dioxane; alkylene glycol monoalkyl and dialkyl ethers, such as propylene glycol monomethyl ether, propylene glycol monoethyl ether, ethylene glycol monomethyl and monoethyl ether, diglyme, and tetraglyme, for example; amides such as dimethylformamide (DMF), dimethylacetamide, dimethylcaprylamide, dimethylcapramide, and N-alkylpyrrolidones; ketones such as acetone, cyclohexanone, acetophenone, butrylolactone; esters based on glyceryl and carboxylic acids, such as glyceryl mono-, di- and triacetate, phthalic esters, ethyl lactate, 2-ethylhexyl lactate; lactams; carbonic diesters; nitriles such as acetonitrile, propionitrile, butyronitrile, and benzonitrile; sulfoxides and sulfones such as dimethyl sulfoxide (DMSO) and sulfolane; carbonates such as propylene or butylene carbonate; and combinations of different solvents, additionally containing alcohols such as methanol, ethanol, n- and iso-propanol, and n-, iso-, tert- and 2-butanol. However, many of these organic solvents pose serious fire hazards in storage, shipping, and/or use conditions. Therefore, most, if not all, of these solvents may not be suitable for the present invention. In one aspect, the present invention comprises a solvent that is non-flammable or only has low-flammability characteristics in order to provide a SLES solution without the use of fire hazard solvents. In preferred embodiments, the present invention comprises hexylene glycol (“2-methylpentane-2,4-diol,” CAS 107-41-5 from Solvay) as a solvent. The solvent may be present in the present invention at about 1% to about 30% by weight.

In another aspect, the present invention additionally comprises one or more co-solvents. Preferably, the co-solvent comprises a non- or low-flammable solvent or a combination of non- and/or low-flammable solvents. In preferred embodiments, the present invention comprises hexylene glycol and at least one co-solvent selected from the group consisting of diethylene glycol, ethylene glycol, proplyene glycol, diproplyene glycol methyl ether, propylene glycol monomethyl ether or combinations thereof. In more preferred embodiments, the present invention comprises hexylene glycol and co-solvents diethylene glycol (CAS 111-46-6 available from MEGlobal), dipropylene glycol methyl ether (“(2-methoxymethylethoxy) propanol,” “2-(2-methoxypropoxy)propanol,” “dipropylene glycol monomethyl ether,” “DPM,” DOWANOL™ DPM glycol ether, CAS 34590-94-8 (mixed isomers) available from DOW), and/or propylene glycol monomethyl ether (“1-methoxy-2-propanol,” or “propylene glycol methyl ether,” DOWANOL™ PM, CAS 107-98-2 available from DOW). The co-solvent (including mixtures thereof) may be present in the present invention at about 0.1% to about 90% by weight. Preferably, the co-solvent (including mixtures thereof) may be present in the present invention at about 1% to about 50% by weight of said composition.

In yet another aspect, the present invention comprises a liquid agrochemical composition comprising an active agrochemical agent and a surfactant-solvent blend solution as described above. The active agrochemical agent may include at least one of the group consisting of a herbicide, insecticide, fungicide, miticide, fertilizer, or plant growth regulator, or combinations thereof. In some embodiments, the present invention may be a concentrated liquid agrochemical composition formulation. In preferred embodiments, the present invention is a concentrated liquid agrochemical composition solution capable of being stored and pumped or poured at freezing or near-freezing temperatures or it may be diluted with an appropriate aqueous solution capable of being sprayed at freezing or near-freezing temperatures.

In some embodiments, the liquid agrochemical composition of the present invention comprises a water-soluble active herbicide agent selected from the group consisting of glufosinate, salts thereof, and/or other similar active compounds. In preferred embodiments, the liquid agrochemical composition of the present invention comprises the ammonium salt of glufosinate (CAS 77182-82-2).

Preferably, the liquid agrochemical composition spray solution of the present invention is applied to an “agricultural substrate” in a “sufficient amount” to have an appropriate desired effect. An agricultural substrate is a living or growing plant that is intended to be affected by application of a liquid agrochemical composition spray solution. For example, a liquid agrochemical composition spray solution of the present invention comprising a herbicide active agrochemical agent will be applied in sufficient amount to damage or inhibit the growth of unwanted plants (i.e., the agricultural substrate) growing in an undesirable area. More preferably, the sufficient amount of the liquid agrochemical composition spray solution of the present invention is an amount that will not adversely affect agricultural crops to be protected by application of a liquid agrochemical composition spray solution.

The resulting mixtures and liquid agrochemical compositions may optionally comprise secondary chemical agents, depending on the application of the mixture/composition. For example, a herbicide containing liquid agrochemical compositions of the present invention may optionally include such secondary chemical agents known in the art as defoamers, dispersants, wetting agents, emulsifiers, penetrants, antifreezes, dyes to provide color, pH buffers and/or modifiers, and other known compounds for altering or enhancing the performance or physical/chemical characteristics of said liquid agrochemical compositions.

### EXAMPLES

The following Examples 1-7 are provided to illustrate the unexpected superior performance of surfactant-solvent blend solutions containing 30% hexylene glycol solvent. Viscosity results of 70% SLES diluted with various glycol are solvents shown in Table 1. High active 70% SLES (BASF) was mixed with 10, 20, and 30% of various glycol solvents (glycerin, propylene glycol, hexylene glycol, dipropylene glycol, diethylene glycol, ethylene glycol, and PEG-200), then viscosity was measured. Viscosity measurement conditions: viscosity in cps, Brookfield Viscometer, number 2 spindle at 12 rpm, 25° C. Hexylene glycol is superior to all glycols tested at 30% with 70% high active SLES.

TABLE 1

| | Solvent | | | | | | |
|---|---|---|---|---|---|---|---|
| | | 2 | 3 | 4 | 5 | 6 | 7 |
| % | 1 | Propylene | Hexylene | Dipropylene | Diethylene | Ethylene | PEG- |
| solvent | Glycerin | glycol | glycol | glycol | glycol | glycol | 200 |
| 10% | gel | gel | gel | gel | gel | gel | gel |
| 20% | gel | gel | 1000 | 600 | gel | gel | gel |
| 30% | gel | 188 | 50 | 625 | gel | gel | gel |

The following Examples 8-18 are provided to illustrate the unexpected superior performance of surfactant-solvent blend solutions containing a blend of hexylene glycol, diethylene glycol, and DPM solvents. Surfactant-solvent blend solutions were prepared containing 60% of high active SLES 70% (BASF), 10 to 15% additional surfactant(s), and diluted with 25 to 30% of various glycol solvents in Table 2. The prepared example solutions 8-18 were then observed for liquid or gel phase state at 22° C., 4° C., and 50° C.

The data in Table 2 indicate that not all glycols are suitable solvents for high active SLES. Diethylene glycol, ethylene glycol, polyethylene glycol 200, and glycerin all form gels at 22° C. and are not suitable viscosity reducers. At 22° C., hexylene glycol, propylene glycol dipropylene glycol and blends of hexylene glycol and diethylene glycol form clear solutions. At 4° C., the only solvent blend that is fluid is a blend of diethylene glycol with hexylene glycol. Both individual components form gels at 4° C. Only the surfactant-solvent blend solution containing hexylene glycol, diethylene glycol, and DPM solvents was at least a substantially single phase liquid at all temperatures tested. Unless indicated otherwise, all percentages are amounts by weight.

TABLE 2

| Formula (%) | 8 | 9 | 10 | 11 | 12 | 13 | 14 | 15 | 16 | 17 | 18 |
|---|---|---|---|---|---|---|---|---|---|---|---|
| Diethylene | 23 | 28 | | | | | | | 18 | 18 | 18 |
| glycol | | | | | | | | | | | |
| Hexylene | 5 | | 28 | | | | | | 5 | 5 | 5 |
| glycol | | | | | | | | | | | |
| Ethylene | | | | 28 | | | | | | | |
| glycol | | | | | | | | | | | |
| Propylene | | | | | 28 | | | | | | |
| glycol | | | | | | | | | | | |
| Dipropylene | | | | | | 28 | | | | | |
| glycol | | | | | | | | | | | |
| PEG 200 | | | | | | | 28 | | | | |
| Glycerin | | | | | | | | 28 | | | |
| Ecosurf | | | | | | | | | 5 | | |
| EH-6 | | | | | | | | | | | |
| Surfonic | | | | | | | | | | 5 | |
| L-24-3 | | | | | | | | | | | |
| Ecosurf | | | | | | | | | | | 5 |
| EH-3 | | | | | | | | | | | |
| DPM | 2 | 2 | 2 | 2 | 2 | 2 | 2 | 2 | 2 | 2 | 2 |
| AGNIQUE ® | 10 | 10 | 10 | 10 | 10 | 10 | 10 | 10 | 10 | 10 | 10 |
| PG 8105 | | | | | | | | | | | |
| SLES (70%) | 60 | 60 | 60 | 60 | 60 | 60 | 60 | 60 | 60 | 60 | 60 |
| BASF | | | | | | | | | | | |
| at 22° C. | clear | gel | clear | gel | clear | clear | gel | gel | clear | clear | clear |
| at 4° C. | slightly | — | cloudy | — | cloudy | cloudy | — | — | solid | solid | paste |
| | hazy | | solid | | solid | solid | | | | | flows |
| at 50° C. | clear | — | bottom | — | bottom | clear | — | — | floc | floc | floc |
| | | | separation | | separation | | | | | | |

The data in Table 3 indicate that only formulas containing (a) a blend of hexylene glycol and diethylene glycol or (b) only propylene glycol form cold stable single phases when blended with the ammonium salt of glufosinate. Diethylene glycol, ethylene glycol, polyethylene glycol (PEG) 200, and glycerin all form gels at 22° C. and are not suitable viscosity reducers when blended with the ammonium salt of glufosinate. At 22° C., hexylene glycol, propylene glycol, dipropylene glycol, and blends of hexylene glycol and diethylene glycol form clear solutions. At 4° C., the only solvent blend that is fluid is a blend of diethylene glycol with hexylene glycol. Both individual components form gels at 4° C.

TABLE 3

| Formula (%) | 19 | 20 | 21 | 22 | 23 | 24 | 25 | 26 | 27 | 28 | 29 |
|---|---|---|---|---|---|---|---|---|---|---|---|
| Diethylene | 23 | 28 | | | | | | | 18 | 18 | 18 |
| glycol | | | | | | | | | | | |
| Hexylene | 5 | | 28 | | | | | | 5 | 5 | 5 |
| glycol | | | | | | | | | | | |
| Ethylene | | | | 28 | | | | | | | |
| glycol | | | | | | | | | | | |
| Propylene | | | | | 28 | | | | | | |
| glycol | | | | | | | | | | | |
| Dipropylene | | | | | | 28 | | | | | |
| glycol | | | | | | | | | | | |
| PEG 200 | | | | | | | 28 | | | | |
| Glycerin | | | | | | | | 28 | | | |
| Ecosurf | | | | | | | | | 5 | | |
| EH-6 | | | | | | | | | | | |
| Surfonic | | | | | | | | | | 5 | |
| L-24-3 | | | | | | | | | | | |
| Ecosurf | | | | | | | | | | | 5 |
| EH-3 | | | | | | | | | | | |
| DPM | 2 | 2 | 2 | 2 | 2 | 2 | 2 | 2 | 2 | 2 | 2 |
| Agnique | 10 | 10 | 10 | 10 | 10 | 10 | 10 | 10 | 10 | 10 | 10 |
| PG 8105 | | | | | | | | | | | |
| SLES (70) | 60 | 60 | 60 | 60 | 60 | 60 | 60 | 60 | 60 | 60 | 60 |
| BASF | | | | | | | | | | | |

51% of the above formulations 19-29, respectively, 22.4% water, 25.7% glufosinate ammonium (97%
PURITY), and 0.90% ammonium hydroxide (30%)

| | | | | | | | | | | | |
|---|---|---|---|---|---|---|---|---|---|---|---|
| Glufosinate | clear | — | Phase | — | clear | Phase | — | — | Phase | Phase | Phase |
| 280 g/L SL | | | separation | | | separation | | | separation | separation | separation |
| at 4° C. | | | | | | | | | | | |
| Viscosity | 500 cps | — | not tested | — | 800 cps | — | — | — | not tested | not tested | not tested |
| #2 spindle | | | | | | | | | | | |
| 12 rpm | | | | | | | | | | | |
| at 6° C. | | | | | | | | | | | |

The terms “comprising,” “including,” and “having,” as used in the claims and specification herein, shall be considered as indicating an open group that may include other elements not specified. The terms “a,” “an,” and the singular forms of words shall be taken to include the plural form of the same words, such that the terms mean that one or more of something is provided. The term “one” or “single” may be used to indicate that one and only one of something is intended. Similarly, other specific integer values, such as “two,” may be used when a specific number of things is intended. The terms “preferably,” “preferred,” “prefer,” “optionally,” “may,” and similar terms are used to indicate that an item, condition or step being referred to is an optional (not required) feature of the invention.

The invention has been described with reference to various specific and preferred embodiments and techniques. However, it should be understood that many variations and modifications may be made while remaining within the spirit and scope of the invention. It will be apparent to one of ordinary skill in the art that methods, devices, device elements, materials, procedures and techniques other than those specifically described herein can be applied to the practice of the invention as broadly disclosed herein without resort to undue experimentation. All art-known functional equivalents of methods, devices, device elements, materials, procedures and techniques described herein are intended to be encompassed by this invention. Whenever a range is disclosed, all sub-ranges and individual values are intended to be encompassed. This invention is not to be limited by the embodiments disclosed, including any exemplified in the specification, which are given by way of example and not of limitation.

All references throughout this application, for example patent documents including issued or granted patents or equivalents, patent application publications, and non-patent literature documents or other source material, are hereby incorporated by reference herein in their entireties, as though individually incorporated by reference, to the extent each reference is at least partially not inconsistent with the disclosure in the present application (for example, a reference that is partially inconsistent is incorporated by reference except for the partially inconsistent portion of the reference).

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

We claim:

1. A method for reducing the viscosity of a high active concentrated alkyl ether sulfate surfactant solution comprising: providing a high active concentrated alkyl ether sulfate surfactant solution and mixing hexylene glycol as a solvent into said high active concentrated alkyl ether sulfate surfactant solution.

2. The method of claim 1, wherein said high active concentrated alkyl ether sulfate surfactant is selected from the group comprising sodium lauryl ether sulfate and ammonium lauryl ether sulfate.

3. The method of claim 1, further comprising mixing at least one co-solvent in the amount of about 0.1% to about 90% of the total solvent amount by weight into said high active concentrated alkyl ether sulfate surfactant solution.

4. The method of claim 3, wherein said at least one co-solvent is selected from the group consisting of diethylene glycol, ethylene glycol, proplyene glycol, dipropylene glycol methyl ether, propylene glycol monomethyl ether, or combinations thereof.

5. The method of claim 3, wherein said at least one co-solvent is diethylene glycol.

6. The method of claim 3, wherein said at least one co-solvent is a combination of diethylene glycol and dipropylene glycol methyl ether.

7. The method of claim 4, further comprising mixing at least one additional surfactant selected from the group consisting of alkylpolyglucosides, alcohol alkoxylates, and combinations thereof in amount of about 0.1% to about 50% by weight into said high active concentrated alkyl ether sulfate surfactant solution.

8. A method for treating an agricultural substrate comprising:
a. Contacting said agricultural substrate with a sufficient amount of a liquid agrochemical composition spray solution containing a surfactant-solvent blend comprising a high active concentrated alkyl ether sulfate surfactant solution and a solvent mixed into said high active concentrated alkyl ether sulfate surfactant solution, wherein said solvent is hexylene glycol.

9. The method of claim 8, wherein said liquid agrochemical composition spray solution comprises an active agrochemical agent selected from the group consisting of a herbicide, an insecticide, a fungicide, a miticide, a fertilizer, or a plant growth regulator, or combinations thereof.

10. The method of claim 9, wherein said herbicide is glufosinate or salts thereof.

11. A liquid agrochemical composition comprising:
a. an active agrochemical agent; and
b. a surfactant-solvent blend solution, wherein said surfactant-solvent blend solution comprises a high active concentrated alkyl ether sulfate surfactant solution and a hexylene glycol solvent.

12. The liquid agrochemical composition of claim 11, wherein said high active concentrated alkyl ether sulfate surfactant is selected from the group comprising sodium lauryl ether sulfate and ammonium lauryl ether sulfate.

13. The liquid agrochemical composition of claim 12, wherein said hexylene glycol solvent comprises about 1% to about 5% by weight of said composition.

14. The liquid agrochemical composition of claim 12, further comprising at least one co-solvent selected from the group consisting of diethylene glycol, ethylene glycol, proplyene glycol, dipropylene glycol methyl ether, propylene glycol monomethyl ether, or combinations thereof.

15. The liquid agrochemical composition of claim 14, wherein said at least one co-solvent is diethylene glycol.

16. The liquid agrochemical composition of claim 14, wherein said at least one co-solvent is a combination of diethylene glycol and dipropylene glycol methyl ether.

17. The liquid agrochemical composition of claim 14, wherein said at least one co-solvent comprises about 1% to about 50% by weight of said composition.

18. The liquid agrochemical composition of claim 12, wherein said high active concentrated alkyl ether sulfate surfactant comprises about 60% to about 90% of the total surfactant amount by weight in said composition.

19. The liquid agrochemical composition of claim 16, further comprising at least one additional surfactant selected from the group consisting of alkylpolyglucosides, alcohol alkoxylates, and combinations thereof.

20. The liquid agrochemical composition of claim 19, wherein said at least one additional surfactant comprises about 0.1% to about 50% by weight of said composition.
